(19) United States
(12) Patent Application Publication
(10) Pub. No.: US 2018/0040997 A1
(43) Pub. Date: Feb. 8, 2018

(54) BRUSH-HOLDER

(71) Applicant: VALEO EQUIPEMENTS ELECTRIQUES MOTEUR, Creteil Cedex (FR)

(72) Inventors: Thierry PALTRIE, Lyon (FR); Maximilien GENTIL, Corbas (FR)

(21) Appl. No.: 15/549,577

(22) PCT Filed: Feb. 4, 2016
(86) PCT No.: PCT/FR2016/050240

§ 371 Date: Aug. 8, 2017

(30) Foreign Application Priority Data
Feb. 13, 2015 (FR) 1551178

(51) Int. Cl. H01R 39/38; H02K 13/00

(52) U.S. Cl. CPC H01R 39/381; H01R 39/385; H02K 13/00

(57) ABSTRACT

The invention mainly concerns a brush holder (10) for an electric motor, in particular the starter motor of a motor vehicle, comprising guide cages (13) for receiving the brushes (15) and a support plate (12) on which the guide cages (13) are positioned. The guide cages (13) are made from an insulating material. The brush holder (10) comprises legs (29) fixed on the support plate (12), around each of which a spiral spring (24) is intended to be mounted in order to exert a force on the brush (15) in such a way as to press the brush (15) against a collector.

The present invention relates to an improved brush-holder of an electric motor for a motor vehicle starter, as well as to the corresponding electric motor and starter. The invention has a particularly advantageous, but not exclusive, application with motor vehicle starters, in particular those which are installed in vehicles equipped with the function of automatic stopping and restarting of the thermal engine (so-called stop and start function).

In a known manner, a brush-holder is fitted around the shaft of the rotor of a starter, such as to make brushes made of electrically conductive material cooperate with an electrical collector integral with the shaft of the rotor. This makes it possible to supply the rotor electrically by switching of the electric current in the conductors of the rotor.

For this purpose, the brush-holder comprises a support plate which supports a series of cages, each of which is used as a receptacle for a brush. Each brush comprises a face which is designed to rub against the conductive plates of the connector which are connected to the winding of the rotor. A resilient means, such as a spring, exerts a force in the direction of the collector on each brush received in a cage, in order to ensure the contact between the brush and the plates of the collector.

The brushes have alternating polarities. Thus, the brushes with positive polarity are connected electrically, via their respective braid, to an inter-brush connector to which there is also connected electrically the supply wire obtained from the contactor of the starter. In addition, the brushes which are designed for the current return are connected electrically to the earth of the machine by means of their respective braid.

In certain brush-holder configurations, it is known to use a spring of a spiral type comprising a wound part fitted on a lug, as well as an arm which extends from an end of the wound part, which arm is designed to be supported on an end face of the brush opposite the face in contact with the plates of the connector.

This type of spiral spring makes it possible to increase the size of the brush for a given brush-holder diameter, since the latter is situated between two brushes, and not between the brush and the head of the motor, as is the case for brush holders which use a helical spring. In addition, the fact of increasing the length of the brush makes it possible for the brush to have a longer service life.

As described in document FR2996369, the cages are made from a thin metal plate, such as to form substantially an omega, the end branches of which are secured on the plate via a securing device. The problem with a configuration of this type is that the dust which is generated by the brushes can generate short-circuits in the starter.

The objective of the invention is in particular to eliminate this disadvantage efficiently, by proposing a brush-holder for an electric motor, in particular for a motor vehicle starter, comprising guide cages which are designed to receive brushes, and a support plate on which the said guide cages are positioned. According to the invention, the said guide cages are made of an insulating material, and the said brush-holder comprises lugs which are secured on the support plate, around each of which a spiral spring is designed to be fitted, in order to exert a force on the brush, such as to place the said brush against a collector.

As a result of the production of the cages from an insulating material, which for example can be integral with the support plate, the invention thus makes it possible to solve the aforementioned problems of short-circuits generated by the powder from the brushes.

According to one embodiment, each lug is situated between two adjacent guide cages. The fact that the brush is situated between two guide cages makes it possible to increase the size of the brush for a given head diameter.

According to one embodiment, the said lugs are made of a metal material. A characteristic of this type makes it possible to ensure efficient retention of the wound part of the spring, since the metal lug can withstand without difficulties the reaction forces applied by the associated spring, unlike a plastic lug.

According to one embodiment, the said lugs are obtained from a metal washer. A configuration of this type makes it possible to rigidify the assembly obtained.

According to one embodiment, the support plate is over-moulded around the lugs, the said support plate preferably being made of plastic. This makes it possible to render the lugs integral with the support plate.

According to one embodiment, the support plate is over-moulded around lugs, and preferably only around the base of the said lugs.

According to one embodiment, the said support plate is over-moulded around the said lugs and the said metal washer, the said support plate preferably being made of a plastic material.

According to one embodiment, the said metal washer comprises a number of parts corresponding to the number of guide cages, which are separated from one another such as to isolate the said brushes from one another. This therefore prevents risks of short-circuits in the starter.

According to one embodiment, the said lugs are secured on the said support plate.

According to one embodiment, the said lugs are added, independently from one another, onto the said support plate.

According to one embodiment, the said lugs are provided with a base which extends along the support plate, and makes it possible to secure the lug on the said support plate.

According to one embodiment, the said lugs are provided with an opening which makes it possible to retain the said lugs during the over-moulding. This makes it possible to guarantee precise positioning of the lugs during the over-moulding operation, by means of indexing tooling comprising fingers which can cooperate with these openings.

According to one embodiment, the said brush-holder comprises curved portions which each project from the support plate, parallel to the lugs, and being designed for guiding of wound parts of the said spiral springs.

According to one embodiment, the said support plate comprises elements for guiding of an interconnector, in order to connect brushes with the same polarity, on the side of a face opposite that which supports the said guide cages.

According to one embodiment, the said guide cages are integral with the said support plate.

The invention also relates to an electric motor, comprising a brush-holder as previously defined.

The invention also relates to the starter of a motor vehicle comprising an electric motor as previously defined.

The invention will be better understood by reading the following description, and examining the figures which accompany it. These figures are provided purely by way of illustration, but in no way limit the invention.

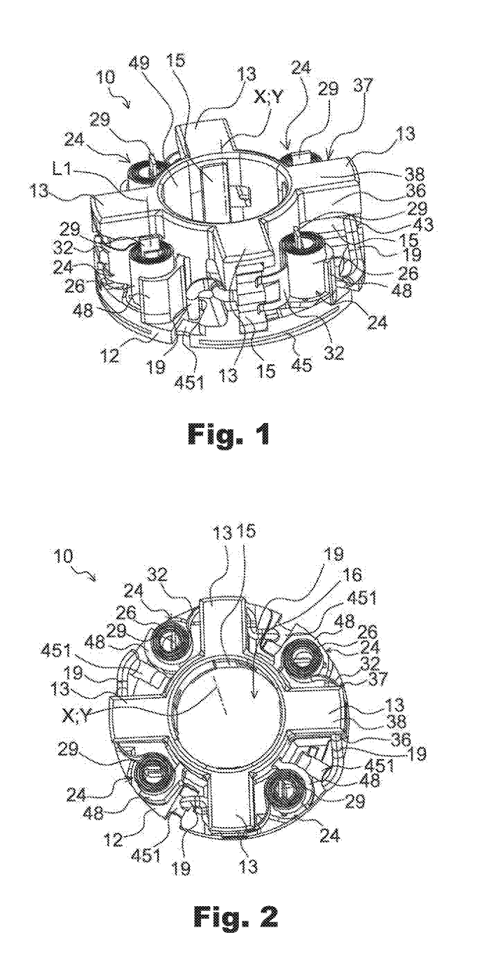

FIGS. 1 and 2 are respectively views in perspective and from above, illustrating a first embodiment of a brush-holder of an electric motor according to the present invention;

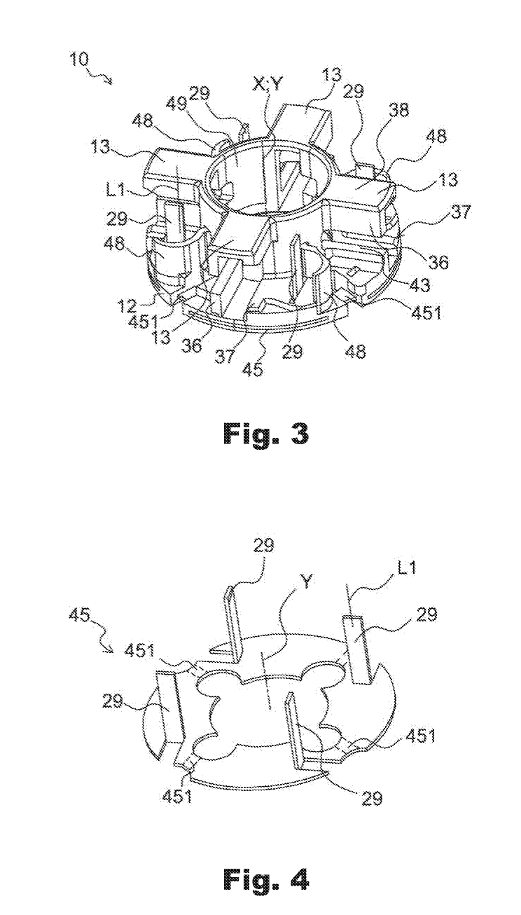

FIG. 3 is a view in perspective of the brush-holder in FIGS. 1 and 2, without the brushes or the spiral springs;

FIG. 4 is a view in perspective of the metal washer used in the brush-holder in the preceding figures, around which the support plate is designed to be over-moulded;

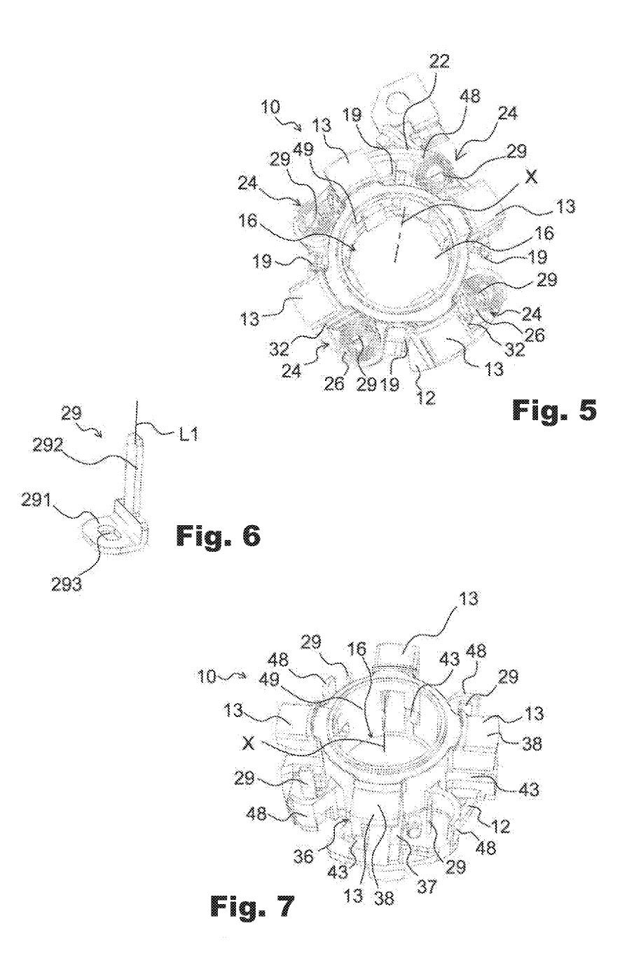

FIG. 5 is a view in perspective illustrating a second embodiment of a brush-holder according to the present invention;

FIG. 6 is a view in perspective of an insert used in the brush-holder in FIG. 5, in order to form the lugs which support the spiral springs;

FIG. 7 is a view in perspective of the brush-holder in FIG. 5, without the brushes or the spiral springs;

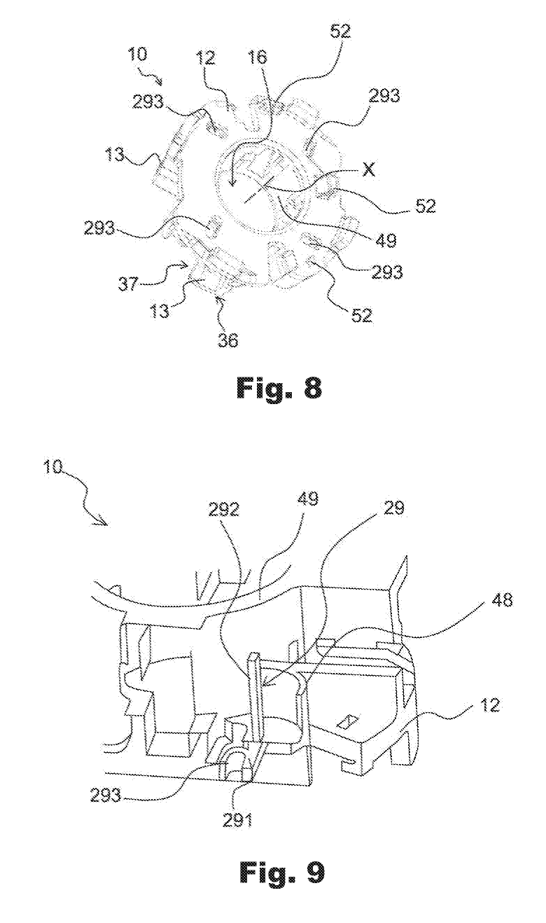

FIG. 8 is a view showing the lower face of the brush-holder in FIG. 7;

FIG. 9 is a view in transverse cross-section of the brush-holder in FIG. 5, at an insert.

Elements which are identical, similar or analogous retain the same reference from one figure to another.

FIGS. 1, 2, and 5 show a brush-holder 10 according to the invention, which is designed to be used with an electric motor of a motor vehicle starter.

This brush-holder 10 with an axis X comprises a support plate 12 with a substantially annular form around the axis X, and a series of guide cages 13, which are each used as a receptacle for a brush 15.

The support plate 12 and the cages 13 which it supports are secured on a cover (not represented) which forms a rear bearing for the rotor shaft of the electrical machine. In addition, the central part of the plate 12 comprises an opening 16. The assembly formed by the support plate 12, the brush cages 13 and the brushes 15, is fitted around the shaft of the rotor of the starter.

Each brush 15 is fitted such as to slide inside a cage 13, which is open such as to open onto the opening 16, in order to allow the brushes 15 to be put into electrical contact with plates supported by a collector of a rotor of an electrical machine.

The brushes 15 have alternating polarities. Thus, the brushes 15 with positive polarity are connected electrically, via their respective braid 19, to a supply wire obtained from the contactor of the starter. In order to connect the braids 19 of two diametrically opposite positive brushes 15 electrically, use is preferably made of an inter-brush connector (not represented). In addition, a bushing 22, which can be seen clearly in FIG. 5, is designed to cooperate with the casing of the starter, in order to ensure the sealing of the brush-holder 10. In addition the brushes 15 with negative polarity, which are designed for the current return, are connected electrically to the earth of the machine by means of their respective braid 19.

The flexible braids 19 are advantageously made of copper or copper alloy. The braids 19 can act as a fuse in the event of excess current caused by malfunctioning of the starter.

In addition, a spiral spring 24, which is associated with each guide cage 13, thrusts the corresponding brush 15 radially towards contact plates of the collector. For this purpose, each spring 24 comprises a wound part 26 formed by a plurality of turns, which part is fitted around a lug 29, as well as an arm 32 which extends from an end of the wound part 26. The arm 32 has an area of support against a portion of the face of the brush 15, opposite the face which is in contact with the plates of the collector. Each lug 29 is situated between two adjacent guide cages 13. The lug 29 has a longitudinal direction of extension L1, which extends axially relative to the axis X.

In addition, each cage 13 has a receptacle for the brush 15, which receptacle is delimited by two lateral walls 36, 37 opposite one another, which are connected to one another by an upper connection wall 38. The lateral walls 36, 37 each comprise an opening 43, which, according to the positioning of the spring 24, will permit the passage of the arm 32 of the spring 24, and/or of the braid 19 of the corresponding brush 15.

In the embodiment in FIGS. 1 to 4, the lugs 29 are obtained from a metal washer 45 with an axis Y, which is combined with the axis X when the washer 45 is integrated with the brush-holder 10.

More specifically, the metal washer 45, which is shown in detail in FIG. 4, has a globally annular form which extends on a plane with orientation which is radial relative to the axis Y. The inner and outer diameters of the washer 45 correspond respectively to the inner and outer diameters of the support plate 12. The lugs 29 are obtained by cutting parts in the washer 45, in this case parts with a rectangular form, which parts are then folded back, such as to extend substantially perpendicularly to the plane of the metal washer 45.

The support plate 12, which is made of plastic material, is over-moulded around the metal washer 45 and the lugs 29. Thus, the washer 45 and the base of the lugs 29, corresponding to the junction between the lugs 29 and the washer 45, are covered by a layer of material which forms the support plate 12. The metal washer 45 thus makes it possible to rigidify the assembly.

In this embodiment, only the base of the lugs 29 is over-moulded. As a variant, not represented in the figures, the entire surface of the lugs 29 can be over-moulded.

In addition, the cages 13, and more specifically the lateral walls 36, 37, are integral with the support plate 12. The cages 13 can be produced by moulding at the same time as the support plate 12, thus forming a single piece. The assembly obtained, formed by the support plate 12, the metal washer 45, and the cages 13, is thus an assembly in a single piece. The support plate 12 and the cages 13 are made of a plastic material, thus ensuring good electrical insulation. As a variant, the support plate 12 and the cages could however be made of any other mouldable insulating material.

Preferably, the brush-holder 10 additionally comprises curved portions 48, which are designed for guiding of the wound parts 26 of the spiral springs 24. These curved portions 48 are annular portions which extend axially relative to the axis X, with an inner diameter corresponding to the outer diameter of the wound part 26 of the springs 24. These curved portions 48 are also produced integrally with the support plate 12, and can also be obtained during the moulding of the assembly.

In addition, in order to increase the rigidity of the cages 13, the front edges of the latter situated on the collector side can be connected to one another by a cylindrical portion 49 with axial orientation which is integral with the cages 13 and the support plate 12.

The metal washer 45 is cut in a number of parts corresponding to the number of guide cages 13, such as to insulate the brushes 15 against one another. This therefore prevents risks of short-circuits. Thus, by means of the removal of strips of material 451 extending between two adjacent cages 13, which can be seen clearly in FIGS. 2 and 4, the washer 45 is cut in four parts, each associated with a corresponding guide cage 13. The cutting operation is carried out after the operation of over-moulding, during which handling of an entire washer 45 is easy. The braids 19 of the brushes 15 with negative polarity can pass via the space which is left free by the removal of the strips of material 451, in order to be connected to the earth of the starter. The strips of material 451 have a width which is reduced in comparison with the average width of the washer 45, in order to facilitate their cutting.

In the embodiment in FIGS. 5 to 9, added-on lugs 29 are used, constituted by metal inserts. As can be seen clearly in FIG. 6, each lug 29 comprises a base 291 and an elongate part 292 obtained from the base 291, around which a spring 24 is designed to be fitted. The direction of longitudinal extension L1 of the part 292 extends substantially perpendicularly to the base 291. As represented, the elongate part 292 can be widened in its part which is lower than the level of the junction with the base 291. The base 291 of the lugs 29 corresponds to the base of the said lugs of the preceding embodiment.

Thus, as is illustrated in FIGS. 5 to 9, the lugs 29 are added, independently from one another, onto the support plate 12.

The support plate 12 made of a plastic material is over-moulded around the base 291 of the lugs 29. Thus, the bases are 291 are covered by a layer of material forming the support plate 12, such that the lugs 29 are rendered integral with the support plate 12 (cf. FIG. 9).

Preferably, in order to guarantee precise positioning of the lugs 29 during the over-moulding operation, the lugs 29 are each provided with a transverse opening 293 provided in their base 291. These openings 293 are designed each to cooperate with a finger of corresponding indexing tooling. The positioning of the lugs 29 is carried out such that, in the final product, each lug 29 is situated in the vicinity of a corresponding guide cage 13, and the direction of extension L1 extends parallel to the axis X of the brush-holder 10.

As a variant, not represented, the lugs 29 of the preceding embodiment illustrated in FIGS. 3 and 4 can each be provided with an opening 293. For example, this opening can be formed in the base of the lug.

In addition, the cages 13, and more specifically the lateral walls 36, 37, can be reproduced identically to the embodiment previously described. The assembly obtained, formed in particular by the support plate 12, the cages 13 and the lugs 29, is thus an assembly in a single piece, as can be seen clearly in FIG. 7.

Preferably, the brush-holder 10 also comprises curved portions 48, which can be reproduced identically to the embodiment previously described.

In addition, as can be seen in FIGS. 5, 7, and 8, the front edges of the cages 13 can be connected to one another identically to the embodiment previously described, i.e. by the cylindrical portion 49, in order to rigidify the moulded assembly obtained.

As illustrated in FIG. 8, the support plate 12 can also comprise elements 52 for guiding of an interconnector on the side of the face opposite that which supports the guide cages 13. Some of these guide elements 52 are constituted in this case by hooks in the form of an “L”, such as to delimit with the face of the support plate 12 a space which is designed to receive a branch of the interconnector. The guide elements 52 can preferably make it possible to retain the interconnector. In the embodiment in FIGS. 1 to 4, the support plate 12 can also comprise guide elements 52 which are situated on the side of the face opposite the cages 13.

As a variant, the support plate 12 is not over-moulded around added-on lugs 29. In this case, after carrying out the moulding of the assembly comprising the support plate 12, the cages s13 and the guide portions 48, the added-on lugs 29 are secured on the support plate 12. For this purpose, the lugs 29 can for example be secured by riveting, snapping on, or screwing, onto the support plate 12.

It should be noted that, in all cases, the fact of using metal lugs 29 makes it possible to ensure efficient retention of the wound part 26 of the spring 24, in that the metal lugs 29 can withstand the forces applied by the spring 24 fitted around each lug 29.

Irrespective of the configuration produced, the risk of short-circuits associated with the dust generated by the brushes 15 is limited, because of the use of the insulating material for production of the cages 13 and the support plate 12.

As a variant, the brush-holder 10 comprises more than four brushes 15, each brush 15 being able for example to be associated with another brush 15 positioned on the opposite side of the plate 12.

The brush-holder 10 is in this case a brush-holder of an electric motor of a motor vehicle starter. As a variant, the brush-holder 10 could also belong to an alternator or to an alternator-starter.

It will be appreciated that the foregoing description has been provided solely by way of example, and does not limit the field of the invention, a departure from which would not be constituted by replacement of the different elements by any other equivalents.

1. Brush-holder (10) for an electric motor, in particular for a motor vehicle starter, comprising:
guide cages (13) which are designed to receive brushes (15);
a support plate (12) on which said guide cages (13) are positioned, wherein said guide cages (13) are made of an insulating material, and wherein said brush-holder (10) comprises lugs (29) which are secured on the support plate (12), around each of which a spiral spring (24) is designed to be fitted, in order to exert a force on a brush (15), such as to place said brush (15) against a collector, wherein said lugs (29) are made of a metal material, and wherein said support plate (12) is over-moulded around said lugs (29), said support plate (12) preferably being made of plastic.

2. Brush-holder according to claim 1, wherein each lug (29) is situated between two adjacent guide cages (13).

3. Brush-holder according to claim 1, wherein said lugs (29) comprise a metal washer (45).

4. Brush-holder according to claim 3, wherein said support plate (12) is over-moulded around said lugs (29) and said metal washer (45).

5. Brush-holder according to claim 3, wherein said metal washer (45) comprises a number of parts corresponding to the number of guide cages (13), which are separated from one another such as to isolate said brushes (15) from one another.

6. Brush-holder according to claim 1, wherein said lugs (29) are added, independently from one another, onto said support plate (12).

7. Brush-holder according to claim 1, wherein said lugs (29) are provided with a base (291) which extends along the support plate (12), and makes it possible to secure the lug (29) on said support plate (12).

8. Brush-holder according to claim 1, wherein the lugs (29) are provided with an opening (293) which makes it possible to retain said lugs (29) during the over-moulding.

9. Brush-holder according to claim 1, wherein said brush-holder (10) comprises curved portions (48) which each project from the support plate (12), parallel to the lugs (29), and being designed for guiding of wound parts (26) of said spiral springs (24).

10. Brush-holder according to claim 1, wherein said support plate (12) comprises elements (52) for guiding of an interconnector, in order to connect brushes (15) with the same polarity, on the side of a face opposite that which supports said guide cages (13).

11. Brush-holder according to claim 1, wherein said guide cages (13) are integral with said support plate (12).

12. Electric motor, comprising a brush-holder (10) as defined according to claim 1.

13. Starter for a motor vehicle comprising an electric motor as defined according to claim 12.

14. Brush-holder according to claim 2, wherein said lugs (29) comprise a metal washer (45).

15. Brush-holder according to claim 4, wherein said metal washer (45) comprises a number of parts corresponding to the number of guide cages (13), which are separated from one another such as to isolate said brushes (15) from one another.

16. Brush-holder according to claim 2, wherein said lugs (29) are added, independently from one another, onto said support plate (12).

17. Brush-holder according to claim 2, wherein said lugs (29) are provided with a base (291) which extends along the support plate (12), and makes it possible to secure the lug (29) on said support plate (12).

18. Brush-holder according to claim 6, wherein said lugs (29) are provided with a base (291) which extends along the support plate (12), and makes it possible to secure the lug (29) on said support plate (12).
